(19) United States
(12) Patent Application Publication
(10) Pub. No.: US 2010/0106764 A1
(43) Pub. Date: Apr. 29, 2010

(54) DATACENTER HOSTING MULTIPLE ONLINE DATA MANAGEMENT SOLUTIONS

(75) Inventors: Michael Chadwick, Chandler, AZ (US); Justin Jilg, Mesa, AZ (US); Greg Schwimer, Cave Creek, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/260,814

(22) Filed: Oct. 29, 2008

(51) Int. Cl. G06F 15/16

(52) U.S. Cl. 709/202

(57) ABSTRACT

Systems of the present inventions allow for hosting multiple online data management solutions in a datacenter. An exemplary system may comprise a plurality of servers located in a datacenter, wherein the servers may be communicatively coupled to a network, and at least one server may be running an email security service; a managed datacenter service; an exchange hosting service; a storage, recovery, and backup service; a network security service; a customer relationship management service; a human resources management service; a financial system management service; and/or a collaboration software service.

### CROSS REFERENCE TO RELATED PATENT APPLICATIONS

This patent application is related to U.S. patent application Ser. No. ______ entitled: “A Control Panel for Managing Multiple Online Data Management Solutions” concurrently filed herewith and also assigned to The Go Daddy Group, Inc.

This patent application is related to U.S. patent application Ser. No. ______ entitled: “Providing Multiple Online Data Management Solutions” concurrently filed herewith and also assigned to The Go Daddy Group, Inc.

### FIELD OF THE INVENTION

The present inventions generally relate to the field of online data management and, more specifically, a datacenter and control panel for providing and managing multiple data management solutions.

### SUMMARY OF THE INVENTION

An example embodiment of a datacenter hosting multiple online data management solutions may comprise a plurality of servers located in a datacenter, wherein the servers may be communicatively coupled to a network, and at least one server may be running an email security service; a managed datacenter service; an exchange hosting service; a storage, recovery, and backup service; a network security service; a customer relationship management service; a human resources management service; a financial system management service; and/or a collaboration software service.

An example embodiment of a control panel for managing multiple online data management solutions may comprise a control panel hosted on at least one server communicatively coupled to a network, wherein the control panel may be accessible to a customer via a client that is also communicatively coupled to the network. The control panel may comprise a plurality of tools for managing an email security service; a managed datacenter service; an exchange hosting service; a storage, recovery, and backup service; a network security service; a customer relationship management service; a human resources management service; a financial system management service; and/or a collaboration software service.

An example embodiment of a method for providing multiple online data management solutions may comprise networking a plurality of servers within a datacenter, wherein at least one server is running a software-enabled data management service comprising an email security service, a managed datacenter service, a shared exchange hosting service, a storage, recovery, and backup service, a network security service; a customer relationship management service; a human resources management service; a financial system management service; and/or a collaboration software service. Each server may be communicatively coupled to a network. A control panel also may be provided, which may be hosted on at least one of the servers. The control panel may comprise a plurality of tools for managing the software-enabled data management services.

The above features and advantages of the present inventions will be better understood from the following detailed description taken in conjunction with the accompanying drawings.

### BRIEF DESCRIPTION OF THE DRAWINGS

FIG. 1 illustrates a possible embodiment of a datacenter hosting multiple online data management solutions.

FIG. 2 illustrates possible embodiments of data management services.

FIG. 3 illustrates possible embodiments of a network.

FIG. 4 illustrates a possible embodiment of a datacenter hosting multiple online data management solutions.

FIG. 5 illustrates possible embodiments of managed datacenter services.

FIG. 6 illustrates possible embodiments of email security services.

FIG. 7 illustrates a possible embodiment of a datacenter hosting multiple online data management solutions.

FIG. 8 illustrates a possible embodiment of a datacenter hosting multiple online data management solutions.

FIG. 9 illustrates possible embodiments of network security services.

FIG. 10 illustrates a possible embodiment of a datacenter hosting multiple online data management solutions and a control panel for managing multiple online data management solutions.

FIG. 11 is a flow diagram illustrating a possible embodiment of a method for providing multiple online data management solutions.

FIG. 12 is a flow diagram illustrating a possible embodiment of a method for providing multiple online data management solutions.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting servers.

Applicant has determined that, however, that presently-existing website hosting systems do not provide individuals or businesses with bundled, reliable, efficient, and economical data management solutions that may be easily managed. For the foregoing reasons, there is a need for the systems and methods for providing and managing multiple online data management solutions and related functionality as described herein.

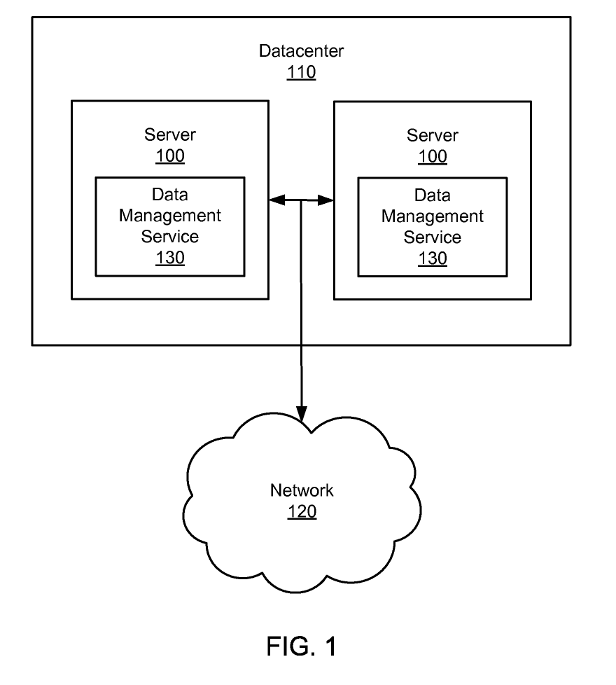

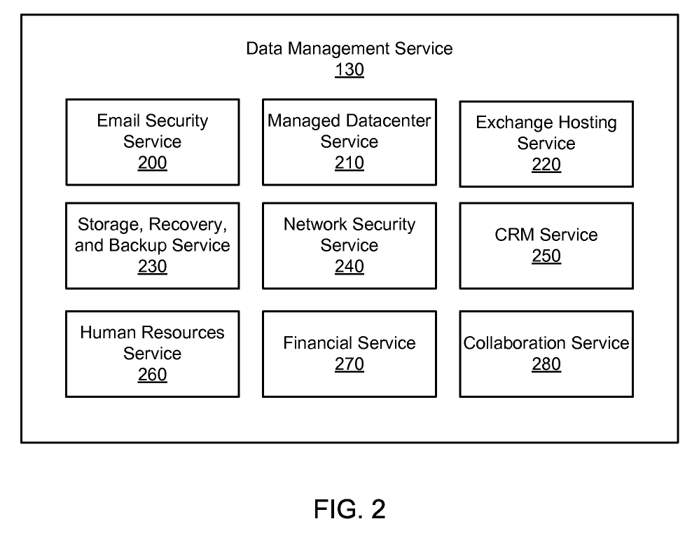

FIG. 1 illustrates a possible embodiment of a system for providing multiple online data management solutions. This example embodiment may comprise a plurality of servers 100 located in a datacenter 110. The servers 100 may be communicatively coupled to a network 120. At least one of the servers 100 may be running at least one software-enabled data management service 130, which (as illustrated in FIG. 2) may comprise an email security service 200, a managed datacenter service 210, an exchange hosting service 220, a storage, recovery, and backup service 230, a network security service 240, a customer relationship management service 250, a human resources management service 260, a financial system management service 270, a collaboration software service 280, and/or any combination thereof.

The datacenter 110 may comprise any mechanism for physically—or virtually—partitioning the servers 100 into a single, but interrelated computing center. As a non-limiting example, the datacenter 110 may comprise a building or other location that stores the servers 100 and necessary related systems (e.g., additional computers, clients, telecommunication networks and equipment, data storage devices, power systems, security systems, environmental controls, switches, routers, load balancers, racks, and/or related equipment). The datacenter 110 may be of any size and configuration. It may comprise a single server 100 rack, or an entire building, depending on system needs. A virtual datacenter 110 may comprise a highly-distributed collection of networked servers 100, perhaps connected communicatively via the network 120, which may perform the function of a traditional, physical datacenter. As a non-limiting example, a virtual datacenter may be implemented with a “cloud computing” solution.

Each of the plurality of servers 100 and/or any other server described herein, could be any computer or program that provides services to other computers, programs, or users either in the same computer or over a computer network. As non-limiting examples, the at least one server 100 could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof).

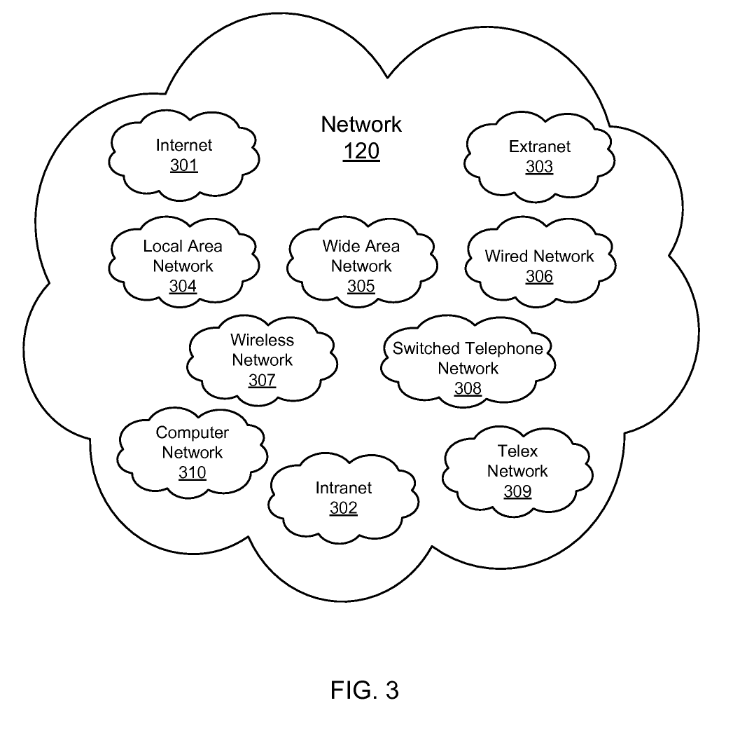

As illustrated in FIG. 3, the example embodiments herein place no limitation on network 120 configurations or connectivity. Thus, as non-limiting examples, the network 120 could comprise the Internet 301, a public switched telephone network 308, a global Telex network 309, computer networks 310 (e.g., an intranet 302, an extranet 303, a local-area network 304, or a wide-area network 305), wired networks 306, wireless networks 307, or any combination thereof. All system components described herein may be communicatively coupled to the network 120 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPoE), and/or any combination thereof.

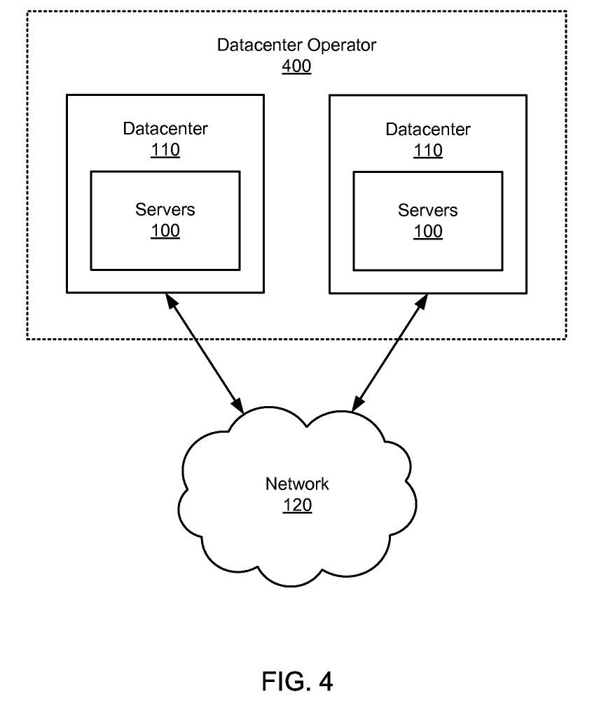

FIG. 4 illustrates an alternate embodiment of a system for providing multiple online data management solutions, wherein the datacenter 110 of FIG. 1 may comprise a plurality of datacenters 110 communicatively coupled to each other via the network 120 and operated by a datacenter operator 400. The datacenter operator 400 may comprise any individual or entity operating a datacenter 110 including, but not limited to a hosting provider, domain name registrar, and/or domain name registry

A data management service 130 may run on at least one of the servers 100 and may comprise any software-enabled product or service that provides customers with management information system (MIS), computing, and/or or network services. Given the complexities and costs of emerging MIS, computing, and networking technologies, individuals and businesses may be unable to manage their organization's technology requirements in their entirety. Accordingly, there is a need for the described data management services 130, which may run on and be made available via a single server 100 or multiple networked datacenters 110. There are multiple benefits associated with the described embodiments including the improved reliability, efficiency, and cost associated with storing and running each data management service 130 within the same server 100 or datacenter 110, which provides for fast and efficient communication between different data management services 130. Such services 130 may include, as non-limiting examples, a managed datacenter service 210, an email security service 200, an exchange hosting service 220, a storage, recovery, and backup service 230, or a network security service 240.

The managed datacenter service 210 may comprise any software-enabled advanced hosting service that may enable users to outsource part (or all) of their hosting and/or data management needs. It may provide application services and/or management for any data processing need, such as website hosting and related internet, intranet, telecommunication, and/or information technology. By outsourcing such needs, the user will be able to focus on their core competencies or specific applications. The managed datacenter service 210 may provide a plurality of services to the customer that may include solution installation, deployment and daily management of the solution, performance testing and troubleshooting with users, solution update monitoring and patching monitoring, network operations center (NOC) management, and/or architecture consulting (e.g., capacity planning, performance and scaling options, and/or database design review).

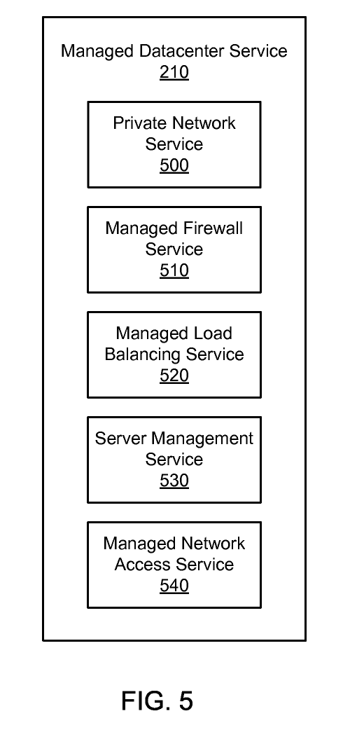

As illustrated in FIG. 5, the managed datacenter service 210 may comprise a private network service 500, a managed firewall service 510, a managed load balancing service 520, a server management service 530, and/or a managed network access service 540. These managed datacenter service 210 solutions may be designed to scale with the user's changing needs and may provide support for numerous server types and services including, but not limited to: load balanced Apache or IIS (Internet Information Services)-based website hosting; single-server Exchange environments; MySQL and MS-SQL database hosting; DBA services; and/or DNS (Domain Name System), firewall, and/or application switching services.

For example, a private network service 500 may comprise any software and/or script that, when executed by a microprocessor on a server 100, may provide the user with access to a dedicated network of servers that may function as the user's own dedicated, secure (i.e., firewalled) computing network. Such a private network may comprise shared, dedicated, or virtually-dedicated servers (and/or other necessary networking equipment as described above). With a shared hosting server, many websites may reside on a single server. Each website may be stored in its own partition (i.e., section or place) on the server to keep it separate from other websites. Shared hosting servers are the most economical hosting option because numerous hosting customers may share in server maintenance cost. Virtual dedicated servers also may comprise a single server, but one that is partitioned into multiple (virtual) servers, each of which may have the appearance to the end user of being the users' own dedicated server. Such virtual dedicated servers may run their own operating system and be independently rebooted. Dedicated servers generally represent the most expensive website hosting option. With dedicated server hosting, the hosting customer may lease a complete server that is dedicated to that customer (i.e., not shared with others). This model may be more flexible than shared or virtual-dedicated hosting because customers may be provided complete control over the server, including the ability to customize its hardware, software, and/or operating system.

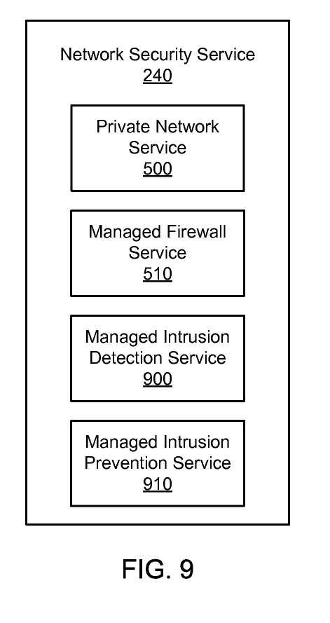

The managed datacenter service 210 also may include a managed firewall service 510 comprising any software and/or script that, when executed by a microprocessor on a server 100, may protect the private network with a dedicated managed firewall and/or virtual private network (VPN) services to provide encrypted access to the private network. The firewall service 510 may be used by the user for Internet-visible applications and/or internal/intranet customer applications. The managed firewall service 510, also may provide distributed denial of service attack (DDOS) prevention systems and/or intrusion prevention and detections systems, such as those described in reference to FIG. 9 below.

The managed load balancing service 520 may comprise any software and/or script that, when executed by a microprocessor on a server 100, may balance application loads across two or more servers 100 used by the private network service 500. A load balancer may be used to balance work between servers 100 to maximize resource utilization, throughput, and/or or response time. Any load balancing software or hardware known in the art, or developed in the future, may be used including, but not limited to proprietary, third-party, or open source systems or software. Examples include MICROSOFT'S NETWORK LOAD BALANCING SERVICES, CISCO APPLICATION CONTROL ENGINE 4710 APPLIANCES, or IPVS (IP VIRTUAL SERVER).

The server management service 530 may eliminate the need for the user to manage his own server's 100 infrastructure. It may comprise any software and/or script that, when executed by a microprocessor on a server 100, may allow a datacenter operator 400 to manage server 100 infrastructure and/or settings on behalf of a user. As non-limiting examples, the following managed servers may be used: Linux web servers running Apache, Windows web servers running IIS, Exchange 2007 servers, MS-SQL 2005 servers, and/or MySQL 5.0 servers.

The managed network access service 540 may comprise any software and/or script that, when executed by a microprocessor on a server 100, may provide users with private connectivity to their private network. The managed network access service 540 may provide users with a managed wide area network (WAN) for location interconnect at the user's office and/or Internet access for office use.

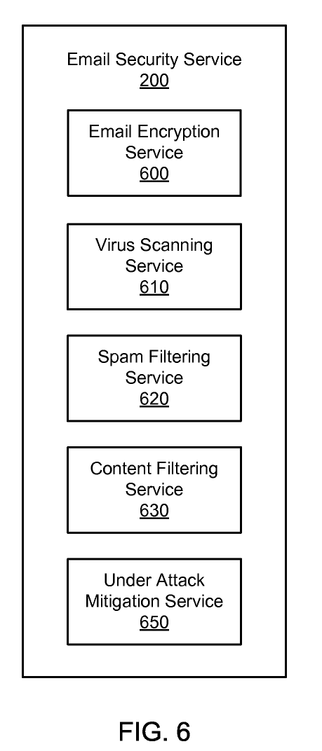

The email security service 200 may comprise any software-enabled service that adds security to any email account or system. As a non-limiting example, an email security service 200 may provide comprehensive spam and/or virus filtering at the network's 120 edge, thereby reducing a user's operational risk (and overhead cost) for his email system. As illustrated in FIG. 6, the email security service 200 may comprise an email encryption service 600, a virus scanning service 610, a spam filtering service 620, a content filtering service 630, or an under attack mitigation service 650. Such an email security service 200 may work in conjunction with both a web-based email platform as well as an on-premise (e.g., client-based) email system. Web-based email systems operate via software residing on servers that are accessible via a client electronic device connected to the Internet. Examples of web-based email include GODADDY.COM WEB-BASED EMAIL, GOOGLE GMAIL, and MICROSOFT HOTMAIL. Such email may be accessed over the Internet by virtually any client. Client-based email, on the other hand, operates via software residing on the client and generally may be accessed only via that client. Examples of client-based email include MICROSOFT OUTLOOK.

The email encryption service 600 may comprise any software and/or script that, when executed by a microprocessor on a server 100, may encrypt electronic communications between email systems. Protocols that may be used include, but are not limited to public-key cryptography, Secure Multipurpose Internet Mail Extensions (S/MIME), Transport Layer Security (TLS), Secure Sockets Layer (SSL), Open Pretty Good Privacy (OpenPGP), identity-based encryption, and/or mail session encryption.

The virus scanning service 610 may comprise any software and/or script that, when executed by a microprocessor on a server 100, may examine incoming and/or outgoing email files (and/or attached files) files to identify and remove any viruses found. Such a service also may scan the server 100 and/or client's memory (e.g., hard drives, cache, etc.) and/or operating system. Many different methods may be used for virus identification. As non-limiting examples, files may be scanned for known viruses matching signatures in a virus dictionary. Alternatively, a heuristic analysis approach may be utilized by identifying suspicious behavior in a scanned file that may indicate infection. Combinations of these “dictionary” and “heuristic” approaches also may be used.

The spam filtering service 620 may comprise any software and/or script that, when executed by a microprocessor on a server 100 may process email and organize it according to predetermined criteria. For example, it may analyze and redirect spam emails from a stream of emails while delivering the desired emails to their intended recipient. Any spam filter methodology known in the art or developed in the future may be used including, but not limited to authentication and reputation-based methods, challenge-response filtering, checksum-based filtering, country-based filtering, DNS-based blacklists, blacklisting, whitelisting, greylisting, Bayesian and rules-based filtering, and/or any combination thereof. Commercially-available spam filters, such as GODADDY.COM SPAMFILTER or CISCO IRONPORT ANTI-SPAM may be used. Alternatively, proprietary filters may be used.

The content filtering service 630 may comprise any software and/or script that may—when executed by a microprocessor on a server 100—analyze the content of emails and/or attached files and, if the content meets predetermined criteria, block the email from delivery. The content filtering service 630 may utilize any content filtering method known in the art or developed in the future including, but not limited to attachment filters (e.g., blocking predefined file types, such as executable programs), mail header filters (e.g., blocking based on header analysis alone), regular expression filters (e.g., blocking based on rules written as regular expressions), phrase filtering (e.g., blocking if particular phrases are found in the content text), proximity filtering (e.g., blocking based on detecting words or phrases when used in proximity to each other), and/or any combination thereof. Commercially-available content filters, such as CISCO IRONPORT CONTENT FILTERING may be used. Alternatively, proprietary filters may be used.

The under attack mitigation service 650 may comprise any software and/or script that, when executed by a microprocessor on a server 100, may minimize the effect of email system attack, such as a distributed denial of service (DDOS) attack, or a spam attack. A DDoS attack occurs when external systems demand the bandwidth or resources of a targeted system's servers, which then become compromised resulting in system slowdown and/or failure. Mitigating such attacks may be accomplished by identifying potential attacks and blocking or diverting potentially malicious traffic. Commercially-available systems, such as CISCO ANOMALY DETECTOR and CISCO GUARD may be used. Alternatively, proprietary systems may be used.

As illustrated in FIG. 2, the data management service 130 also may comprise a shared, multi-tenant Exchange hosting service 220, which may provide users with full access to the MICROSOFT EXCHANGE suite without the responsibility of managing it themselves or the costs associated with a dedicated Exchange server solution. The Exchange hosting service 220 may comprise any software and/or script that, when executed by a microprocessor on a server 100, may provide users with access to MICROSOFT EXCHANGE functionality.

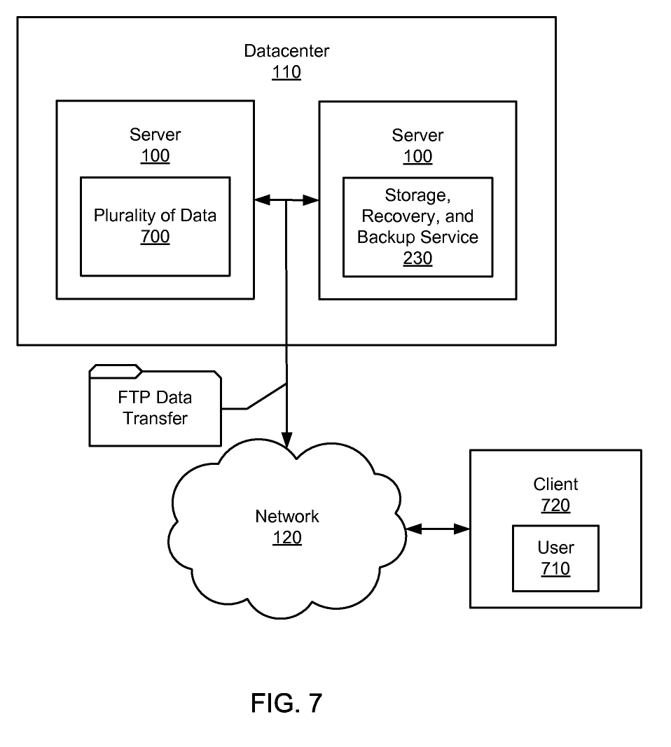

As illustrated in FIG. 2, the data management service 130 also may comprise a storage, recovery, and backup service 230. This may be a component of the managed datacenter service 210 or a separate service provided to users and accessible via the network 120. As illustrated in FIG. 7 a plurality of data 700 may be stored on a server 100 accessible to the user 710 via a client 720 communicatively coupled to the network 120. Alternatively, the data 700 storing server 100 may comprise any network storage device such as, as non-limiting examples, a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future. The client 720, as non-limiting examples, may comprise a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

The storage, recovery, and backup service 230 may provides users 710 with access to stored data 700 by any method of data transfer know in the art or developed in the future including, but not limited to file transfer protocol (FTP) access. Viable data transfer methods can generally be classified in two categories: (1) “pull-based” data transfers where the receiver initiates a data transmission request; and (2) “push-based” data transfers where the sender initiates a data transmission request. Both types are expressly included in the embodiments illustrated herein, which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known in the art or developed in the future may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

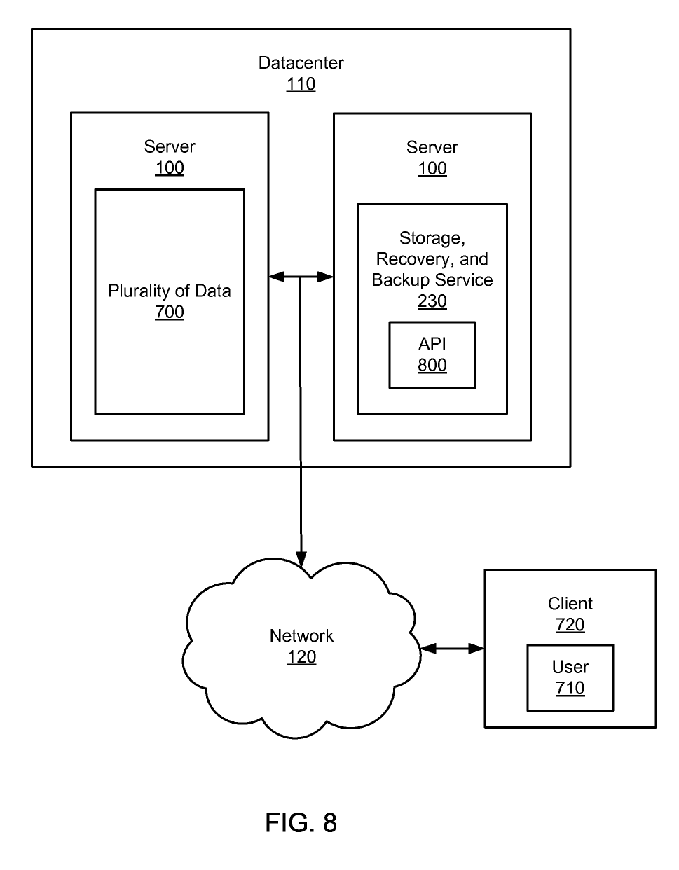

As illustrated in FIG. 8, data 700 access also may be provided via an exposed application programming interface (API) 800 in the storage, recovery, and backup service 230. The API 800 may comprise a software-to-software interface that specifies the protocol defining how independent computer programs interact or communicate with each other. The API 800 may allow the client's 720 software to communicate and interact with the storage, recovery, and backup service 230—perhaps over the network 120—through a series of function calls (requests for services). It may comprise an interface provided by the storage, recovery, and backup service 230 to support function calls made by the client 720. The API 800 may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

As illustrated in FIG. 2, the data management service 130 also may comprise a network security service 240, which may comprise software-enabled security services for users' 710 own internal networks. This service may provide a set of services for users 710 who desire a managed security solution for their internal systems. Such users 710 may have their own datacenter (and/or other office or facility) they want secured, but not the resources to manage the technology themselves. As illustrated in FIG. 9, the network security service 240 may comprise the above-described private network service 500 and/or managed firewall service 510. Alternatively, and as non-limiting examples, the network security service 240 also may comprise a managed intrusion detection service 900 and/or a managed intrusion prevention service 910.

The managed intrusion detection service 900 may comprise software and/or scripts running on a server 100 that may detect unwanted system access, manipulation, and/or disabling via the network 120. Any method known in the art or developed in the future may be used including, but not limited to a network intrusion detection system (NIDS), protocol-based intrusion detection system (PIDS), application protocol-based intrusion detection system (APIDS), host-based intrusion detection system (HIDS), and/or a hybrid intrusion detection system. Commercially-available systems, such as CISCO INTRUSION DETECTION SYSTEM may be used. Alternatively, proprietary systems may be used.

The managed intrusion prevention service 910 may comprise software and/or scripts running on a server 100 that may monitor a user's 710 internal computer network and/or systems unwanted behavior. If such behavior is identified, the service may react, in real-time, to block or prevent such activities. The managed intrusion prevention service 910, for example, may monitor system traffic for malicious code and/or other attacks. If such unwanted behavior is identified, the service may block the unwanted traffic, but allow all other traffic to pass. Any method known in the art or developed in the future may be used including, but not limited to network intrusion prevention systems (NIPS), content-based IPS (CBIPS), protocol analyzers, and /or rate-based IPS (RBIPS). Commercially-available systems, such as CISCO INTRUSION PREVENTION SYSTEM may be used. Alternatively, proprietary systems may be used.

As illustrated in FIG. 2, the data management service 130 also may comprise a customer relationship management service 250. Customer relationship management (CRM) is a term of art used to describe methodologies, systems, and/or methods utilized by a company to manage customer-company interfaces. As a non-limiting example, the CRM service 250 may comprise a software suite, perhaps running on the above-described servers 100, that may support such methodologies, systems, and/or methods. For example, the CRM service 250 may comprise modules for supporting, as non-limiting examples, front office operations, back office operations, business relationships, and/or business analytics. It may comprise memory in which data regarding current and/or prospective customers is stored. Such information may be accessed and/or entered by the user 710, such company employees in various departments (e.g., sales, marketing, customer service, training, human resources, etc.). Commercially available software packages, such as SAP CUSTOMER RELATIONSHIP MANAGEMENT (CRM) SOFTWARE or ORACLE CUSTOMER RELATIONSHIP MANAGEMENT may be used. Alternatively, open-source or proprietary software may be implemented.

As illustrated in FIG. 2, the data management service 130 also may comprise a human resources management service 260, perhaps running on the above-described servers 100, such as a Human Resource Management System (HRMS) or Human Resource Information System (HRIS) system. Such a system may comprise a software-enabled suite of applications for businesses or organizations that may automate numerous human resources and/or payroll systems. As a non-limiting example, the human resources management service 260 may comprise a collection of modules including, but not limited to, a payroll module, work time collection module, (e.g., for collecting time and/or other work-related information), a benefits administration module, a training module, and/or a recruiting module. Commercially available software packages, such as SAP HR or ORACLE HRMS may be used. Alternatively, open-source or proprietary software may be implemented.

As illustrated in FIG. 2, the data management service 130 also may comprise a financial system management service 270, perhaps itself comprising financial, accounting, and/or tax software running on the above-described servers 100. The financial system management service 270 may be accessible to a user 710, such as a business, via the network 120 and may provide any and all financial software applications necessary to run a business, without the business having to purchase, install, and maintain such software their own, internal, computer systems. It may include modules for managing accounts receivable, accounts payable, a business ledger, billing, inventory, purchase and sales orders, financial reporting, compliance, and tax functions. As a non-limiting example, the financial system management service 270 may comprise commercially available software packages, such as MICROSOFT DYNAMICS, INTUIT QUICKBOOKS, and/or INTUIT TURBOTAX SMALL BUSINESS. Alternatively, open source or proprietary software may be implemented.

As illustrated in FIG. 2, the data management service 130 also may comprise a collaboration software service 280, which may comprise any software application designed to assist people engaged a common task achieve their goals. Such software may run on the above-described servers 100 and may comprise email, calendaring, project management, Internet forum, text, chat, wiki, telephony, videoconferencing, document and application sharing, and/or social network applications. As a non-limiting example, commercially available software packages, such as MICROSOFT SHAREPOINT, may be used. Alternatively, open source (e.g., CITADEL/UX) or proprietary applications may be implemented.

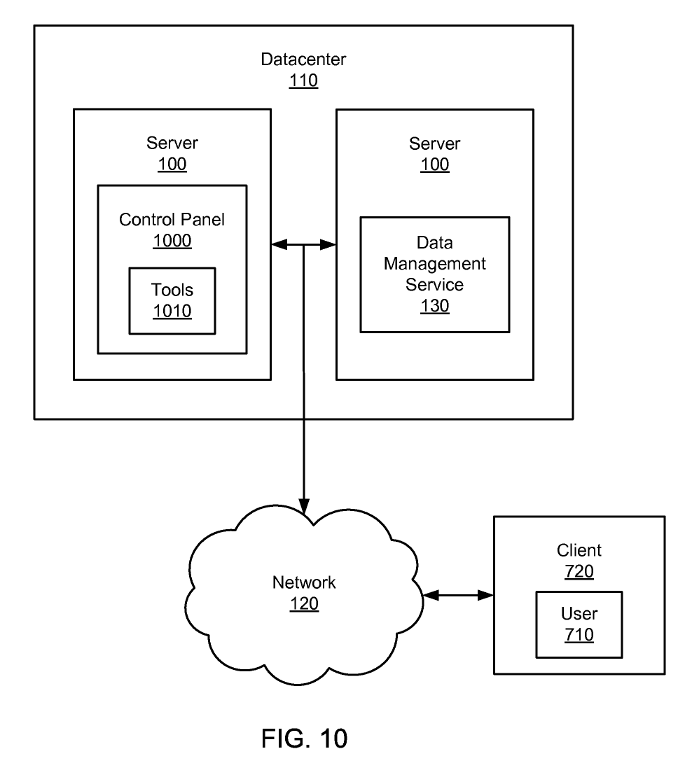

FIG. 10 illustrates an alternate embodiment of a system for providing multiple online data management solutions comprising a control panel 1000 hosted on at least one server 100 communicatively coupled to a network 120. The control panel 1000 may comprise a plurality of tools 1010 for managing a data management service 130 and may be accessible to a user 710 via a client 720 communicatively coupled to the network 120. The control panel 1000 may provide user's 710 with a single tool for controlling all of their data management service 130, which, as described in detail above, may comprise an email security service 200, a managed datacenter service 210, an exchange hosting service 220, a storage, recovery, and backup service 230, a network security service 240, a customer relationship management service 250, a human resources management service 260, a financial system management service 270, a collaboration software service 280, and/or any combination thereof, each of which may comprise software and/or scripts running on a plurality of servers 100 located in at least one datacenter 110. As described in detail above, the datacenter 110 may comprise a physical datacenter, a virtual datacenter, and/or any combination thereof.

The control panel 1000 may comprise a plurality of software-enabled tools 1010, perhaps comprising data fields, dialog boxes, drop-down menus, lists, etc., allowing the user 710 to configure, customize, and/or utilize any of the data management services 130. As non-limiting examples, the control panel 1000 may comprise a single webpage or multiple interconnected and related webpages (ie., a website) resolving from a domain name, each of which may provide access to multimedia content (e.g., text files, audio files, video files, graphics files, executable files, etc.). The control panel 1000 may be hosted on one of the servers 100 within the datacenter 110 or, alternatively, on any client or server communicatively coupled to the network 120 and may comprise any collection of data and/or files accessible via a browser on a client 720 having access to the network 120.

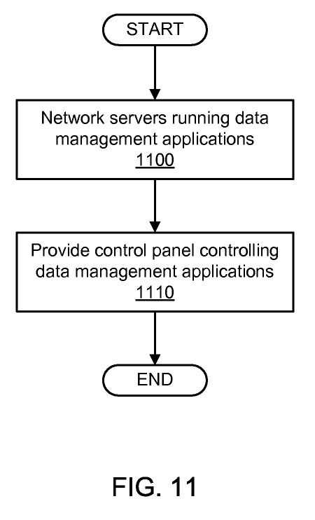

As illustrated in FIG. 11, an example embodiment of a method for providing multiple online data management solutions may comprise networking a plurality of servers 100 within a datacenter 110 (Step 1100), wherein at least one server 100 is running a software-enabled data management service 130 comprising an email security service 200, a managed datacenter service 210, a shared exchange hosting service 220, a storage, recovery, and backup service 230, a network security service 240, a customer relationship management service 250, a human resources management service 260, a financial system management service 270, a collaboration software service 280. Each server 100 may be communicatively coupled to a network 120. A control panel 1000 also may be provided (Step 1110), which may be hosted on at least one of the servers 100. The control panel 1000 may comprise a plurality of tools 1010 for managing the software-enabled data management services 130.

Servers 100 may be networked (Step 1100) to each other by any method of communicatively coupling servers known in the art of developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), the Internet, and/or any combination thereof.

The control panel 1000 may be provided (Step 1110), as a non-limiting example, by hosting a webpage or website resolving from a domain name that provides the plurality of tools 1010 for managing the data management services 130, which are described above. Such a control panel 1000 website may be hosted on any server 100 or client 720 accessible over the network 120.

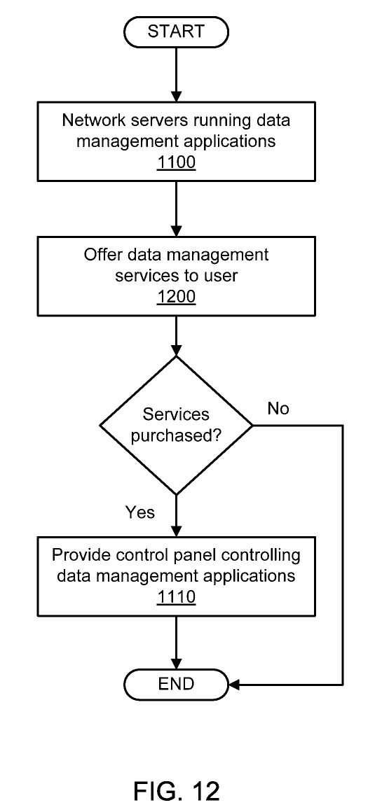

As illustrated in FIG. 12, an alternate method may, in addition to the above-described steps, further comprise the steps of, (prior to providing a control panel 1000) offering at least one data management service 130 for sale to a user 710 (Step 1200). The offer for purchase may be made in any manner, perhaps via a hosting provider's website. If purchased, the control panel 1000 may be provided to the user 710 as described above (Step 1100).

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A system, comprising: a plurality of servers located in a datacenter, said plurality of servers communicatively coupled to a network, wherein at least one of said plurality of servers is running a plurality of software-enabled data management services comprising an email security service; a managed datacenter service; a shared exchange hosting service; a storage, recovery, and backup service; a network security service; a customer relationship management service; a human resources management service; a financial system management service; and a collaboration software service.

2. The system of claim 1, wherein said datacenter comprises a plurality of datacenters communicatively coupled to each other via said network and operated by a datacenter operator.

3. The system of claim 1, wherein said network is selected from the group consisting of the Internet, a public switched telephone network, a global Telex network, a computer network, an intranet, an extranet, a local-area network, a wide-area network, a wired network, and a wireless network.

4. The system of claim 3, wherein said managed datacenter service is selected from the group consisting of a private network service, a managed firewall service, a managed load balancing service, a server management service, and a managed network access service.

5. The system of claim 4, wherein said email security service is selected from the group consisting of an email encryption service, a virus scanning service, a spam filtering service, a content filtering service, and an under attack mitigation service.

6. The system of claim 5, wherein said storage, recovery, and backup service provides a user with file transfer protocol access to a plurality of data stored on at least one of said plurality of servers via a client communicatively coupled to said network.

7. The system of claim 5, wherein said storage, recovery, and backup service comprises an application programming interface providing a user with access to a plurality of data stored on at least one of said plurality of servers via a client communicatively coupled to said network.

8. The system of claim 5, wherein said network security service is selected from the group consisting of a private network service, a managed firewall service, a managed intrusion detection service, and a managed intrusion prevention service.

9. The system of claim 5, further comprising a control panel hosted on said at least one server, said control panel being accessible to a user via a client communicatively coupled to said network and comprising a plurality of tools for managing said at least one software-enabled data management service.

10. The system of claim 9, wherein said control panel comprises a webpage.

11. The system of claim 9, wherein said control panel comprises a website.

12. The system of 11, wherein said datacenter comprises a physical datacenter.

13. The system of claim 11, wherein said datacenter comprises a virtual datacenter.

14. A system, comprising: a plurality of servers located in a datacenter, said plurality of servers communicatively coupled to a network, wherein at least one of said plurality of servers is running at least one software-enabled data management service selected from the group consisting of an email security service; a managed datacenter service; a shared exchange hosting service; a storage, recovery, and backup service; a network security service; a customer relationship management service; a human resources management service; a financial system management service; and a collaboration software service.

15. The system of claim 14, wherein said datacenter comprises a plurality of datacenters communicatively coupled to each other via said network and operated by a datacenter operator.

16. The system of claim 14, wherein said network is selected from the group consisting of the Internet, a public switched telephone network, a global Telex network, a computer network, an intranet, an extranet, a local-area network, a wide-area network, a wired network, and a wireless network.

17. The system of claim 16, wherein said managed datacenter service is selected from the group consisting of a private network service, a managed firewall service, a managed load balancing service, a server management service, and a managed network access service.

18. The system of claim 17, wherein said email security service is selected from the group consisting of an email encryption service, a virus scanning service, a spam filtering service, a content filtering service, and an under attack mitigation service.

19. The system of claim 18, wherein said storage, recovery, and backup service provides a user with file transfer protocol access to a plurality of data stored on at least one of said plurality of servers via a client communicatively coupled to said network.

20. The system of claim 18, wherein said storage, recovery, and backup service comprises an application programming interface providing a user with access to a plurality of data stored on at least one of said plurality of servers via a client communicatively coupled to said network.

21. The system of claim 18, wherein said network security service is selected from the group consisting of a private network service, a managed firewall service, a managed intrusion detection service, and a managed intrusion prevention service.

22. The system of claim 18, further comprising a control panel hosted on said at least one server, said control panel being accessible to a user via a client communicatively coupled to said network and comprising a plurality of tools for managing said at least one software-enabled data management service.

23. The system of claim 22, wherein said control panel comprises a webpage.

24. The system of claim 22, wherein said control panel comprises a website.

25. The system of 24, wherein said datacenter comprises a physical datacenter.

26. The system of claim 24, wherein said datacenter comprises a virtual datacenter.
